(19) United States
(12) Patent Application Publication
(10) Pub. No.: US 2018/0244146 A1
(43) Pub. Date: Aug. 30, 2018

(54) Air flap assembly

(71) Applicant: GM GLOBAL TECHNOLOGY OPERATIONS LLC, Detroit, MI (US)

(72) Inventors: Tim Geipert, Muehltal (DE); Thomas Wiech, Aschaffenburg (DE)

(73) Assignee: GM GLOBAL TECHNOLOGY OPERATIONS LLC, Detroit, MI (US)

(21) Appl. No.: 15/907,495

(22) Filed: Feb. 28, 2018

(30) Foreign Application Priority Data
Feb. 28, 2017 (DE) 102017001908.8

(51) Int. Cl. B60K 11/08

(52) U.S. Cl. CPC B60K 11/085

(57) ABSTRACT

An air flap assembly for a motor vehicle has a frame and at least one vane which is pivotable about an axle between an open position and a closed position in an opening in the frame and is supported on two struts of the frame extending transversely to the axle. The axle divides the vane into a first and a second blade, which are elongated in the direction of the axle. The length of the first blade is greater than the distance between the two struts, and the first blade has at least one narrow side sealing surface, which in the closed position is located opposite a sealing surface of one of the struts forming a seal.

### CROSS-REFERENCE TO RELATED APPLICATION

This application claims priority to German Patent Application No. 102017001908.8, filed Feb. 28, 2017, which is incorporated herein by reference in its entirety.

### TECHNICAL FIELD

The present disclosure pertains to an air flap assembly, particularly for controlling the supply of air to a radiator in a motor vehicle.

### BACKGROUND

An air flap assembly is known from DE 10 2013 213 136 A1 for example. It includes two groups of vanes elongated in the transverse direction of the vehicle, each of which is pivotable about a longitudinal axle between an open position and a closed position. Each air flap is supported by two carrier components in bearing bushings arranged with vertical spacing between them. When these carrier components are installed in a vehicle body independently of each other, the distance between them may vary due to manufacturing tolerances. In order to compensate for these tolerances, a gap must be left between the vanes and the carrier components such that it is not possible for the air flap assembly to be closed completely, and consequently a constant stream of air flows through the radiator during the journey, regardless of the cooling requirement.

In order to minimize the air resistance and ultimately the energy consumption of the vehicle, it is desirable to be able to suppress the flow of air through the radiator entirely when there is no need for cooling.

### SUMMARY

The present disclosure provides an air flap assembly suitable for this purpose.

According to one configuration of the present disclosure, an air flap assembly includes a frame and at least a first vane which is pivotable about an axle between an open position and a closed position in an opening in the frame and is supported on two struts of the frame extending transversely to the axle. The axle divides the vane into a first and a second blade which are elongated in the direction of the axle. The length of the first blade is greater than the distance between the two struts, and the first blade has at least one sealing surface on the narrow side, which in the closed position is located opposite a sealing surface of one of the struts, forming a seal. Manufacturing tolerances can be compensated here by varying the overlap between the sealing surfaces of the vane and the strut. The sealing effect between the sealing surfaces is maintained as long as the overlap is not lost.

The sealing surfaces of the vane and the strut should have a surface normal which is orientated transversely to the axle, so that the distance between them measured in the direction of the surface normal is reduced by rotating in the direction of the closed position.

The air flap assembly typically has multiple vanes, which may be identical with each other.

A second vane is preferably supported on the struts so as to be pivotable about an axle between an open position and a closed position, like the first vane. The second blade thereof may have a lengthwise sealing surface, which in the closed position is located opposite a lengthwise sealing surface of the first blade of the first vane.

Two sealing surfaces located opposite each other do not necessarily have to touch each other to form a seal. It is it sufficient if a gap between them is small enough to create a labyrinth sealing effect. In the case described above, in which the first vane has sealing surfaces on both the longitudinal and narrow sides, it may be expedient to provide a contactless labyrinth seal between the narrow side sealing surface and the strut of the frame, so that the lengthwise sealing surface and an adjacent vane may touch each other in the closed position.

To ensure that the molding tools used for molding the vanes, particularly injection molding the vanes from plastic are kept simple, the narrow side sealing surface and the lengthwise sealing surface of the first blade may be in the same plane.

The first blade and the axle should be positioned on different sides of this plane. This makes it possible to make space on a simply molded strut for both a sturdy bearing for the vane and an expansive sealing surface.

The second blade of the first vane may also have a lengthwise sealing surface, which lies flush against a further vane or a strut of the frame in sealing manner in the closed position. The first vane has a dogleg or stepped cross-section, so that the lengthwise sealing surfaces of the two blades thereof lie in the same plane, but are located on opposite sides of the vane.

At least the first vane may also be supported with the aid of a journal which extends axially at least beyond the second blade, and preferably beyond the first blade as well, to engage in a bearing bushing on the strut.

The strut may have a recess with a wall surface concentric with the axle between the bearing bushing and the opening, and the first vane may have an outer surface that extends in the circumferential direction, whose radius is larger than the radius of the journal and overlaps the wall surface axially. Such an outer surface contributes to creating a seal of the air flap assembly in the closed position by largely blocking a straight passage between the frontal side of the vane and the strut facing it.

The bearing bushing and the sealing surface may be formed as a single part on a first of the two struts, since the journal of the vane may be pushed into the bearing bushing in the axial direction when the air flap assembly is assembled.

At least a part of this bearing bushing may be formed by an arched piece which protrudes over the sealing surface of the first strut.

It may not be possible to insert the journal in the bearing bushing axially in the second strut, particularly if both struts have already been connected at a fixed distance from each other before the vane is attached. Therefore, a second of the two struts is preferably constructed from at least two components, of which a first forms the sealing surface of the strut and the second component forms at least a part of a bearing bushing.

In order to streamline the assembly of the air flap assembly, the second component should at least constitute a part of bearing bushings of several vanes. To simplify the installation of the air flap assembly in a vehicle body, the air flap assembly is preferably constructed as a cohesive module which can be manipulated as a single unit prior to its installation. For this purpose, particularly the two struts extending transversely to the axle may be connected by a strut which extends in the direction of the axle. The manufacture of the frame may be streamlined by molding the struts which extend transversely to the axle and the strut which extends in the direction of the axle as a single part, particularly by injection molding them from plastic. Each of the struts extending in the direction of the axle may further have a sealing surface which cooperates with a lengthwise sealing surface of one of the vanes.

### BRIEF DESCRIPTION OF THE DRAWINGS

The present disclosure will hereinafter be described in conjunction with the following drawing figures, wherein like numerals denote like elements, and:

FIG. 1 shows a view of the outside of an air flap assembly according to the present disclosure in the closed position;

FIG. 2 shows a view of the inside of the air flap assembly;

FIG. 3 shows a detail of the air flap assembly in the closed position;

FIG. 4 shows the detail of FIG. 3 in the open position;

FIG. 5 shows a top view of two vanes of the air flap assembly in the axial direction;

FIG. 6 shows a perspective view of the vanes;

FIG. 7 is a lengthwise section through two vanes;

FIG. 8 shows a second detail of the air flap assembly in the closed position; and

FIG. 9 shows the detail of FIG. 8 in the open position.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

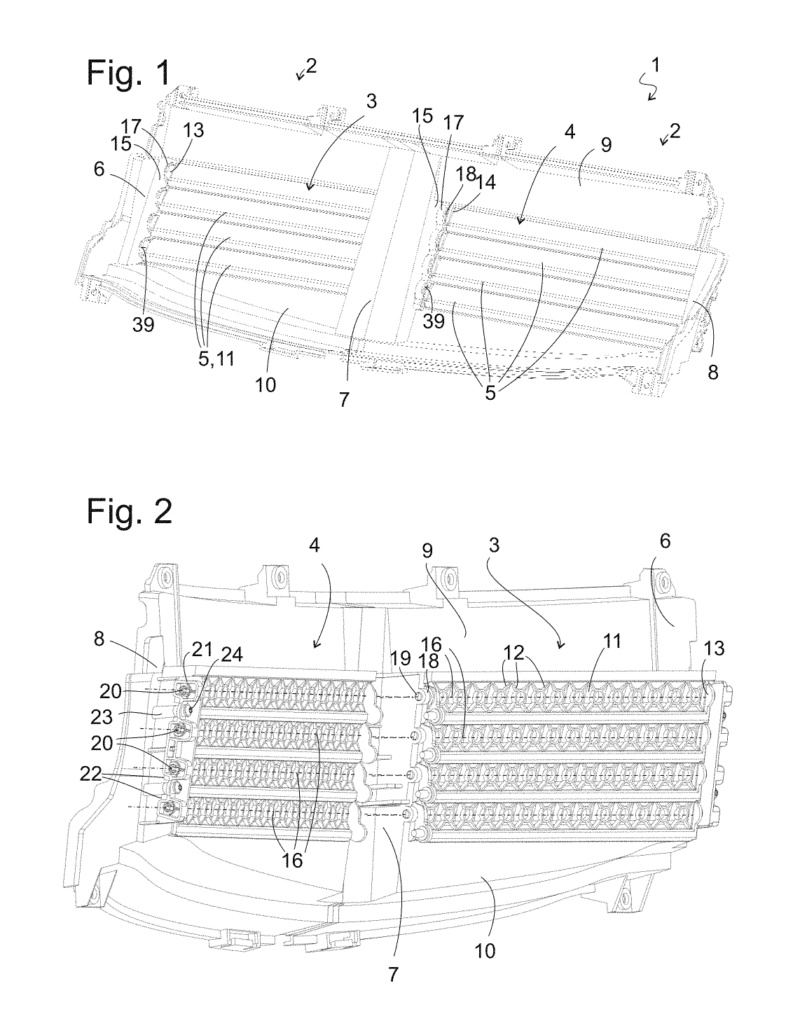

FIG. 1 shows an air flap assembly 1 according to the present disclosure in a perspective view from the outside. The perspective corresponds to the viewing direction of an observer standing in front of the vehicle if the air flap assembly were installed in a vehicle. FIG. 2 shows the same air flap assembly 1 in a view outwards from the inside of the vehicle. A mounting for air flap assembly 1 replicates the contour of a radiator grille (not shown), behind which air flap assembly 1 is installed in the vehicle. In the example considered here, the mounting has two openings 3, 4, which are occupied by vanes 5. The mounting forms an approximately rectangular frame 2 with vertical and horizontal struts 6-10 around each opening 3, 4. Struts 6-10 are made from plastic by injection molding. They may each be embodied as single components that are connected to each other by a snap-lock fitting with frame 2, for example. Alternately, two or more struts may also be combined in one integral unit, or a boundary between different components may pass through a strut.

Vanes 5 each have a horizontally elongated center section 11 in the form of a flat channel which curves convexly on the outer side thereof, that is to say on the side facing the observer shown in FIG. 1, and which is reinforced by intersecting ribs 12 on the concave inner side thereof, shown in FIG. 2. Front plates 13, 14 are formed on each of the ends of the center sections, and are positioned facing and in close proximity to a side wall 15 of the respective adjacent vertical strut 6, 7, or 8. As is shown in FIG. 1, the front plates 13 closest to strut 6 are circular for at least a part of their circumference, the curvature being aligned concentrically with a swivel axle 16 (shown in FIG. 2) of vane 5 in each case. A shim 17 protruding from the side wall 15 of strut 6 follows the edge of front plates 13 with a small separation and covers the gap between front plate 13 and side wall 15 so that air cannot pass through the gap from one side of air flap assembly 1 to the other without being diverted by shim 17.

The swivel axles 16 of vanes 5 mounted in the same opening 3 or 4 are parallel with each other and preferably extend in the same plane 35 (see FIG. 5). Plane 35, in which the axles 16 of vanes 5 extend from opening 3, does not have to be coincident with the corresponding plane 35 of opening 4; in particular, the two planes 35 may intersect in shim 7, as is the case in FIG. 2, so that when viewed from above air flap assembly 1 is slightly kinked in a V-shape and can be accommodated easily in a vehicle with a racked front end without taking up too much space.

The middle vertical strut 7 has two side walls 15 and supports a shim 17 as described above on both side walls. The front plates 14 facing this strut 7 might have a circular edge 40 like front plate 13 (see FIG. 7) in close proximity to an inner side 39 of shim 17 to minimize the passage of air between side wall 15 and front plate 13. In FIG. 1, front plates 14 with a different shape are shown, so that a part of a bearing bushing 18 is still visible behind each shim 17, which bushing accommodates an axle journal of a vane 5. In FIG. 2, the tips of each of these axle journals 19 are visible, and they protrude through bearing bushings 18 and into an interior space in strut 7.

In FIG. 2, axle journals projecting from the front plates of vanes 5 are hidden in bearing bushings 20 of a supporting rail 21 which is attached to a rear edge 22 of the side wall 15 of strut 6 or 8. In the representation in FIG. 2, each of the supporting rails 21 is fastened to screw bosses 23 in struts 6, 8 with screws 24.

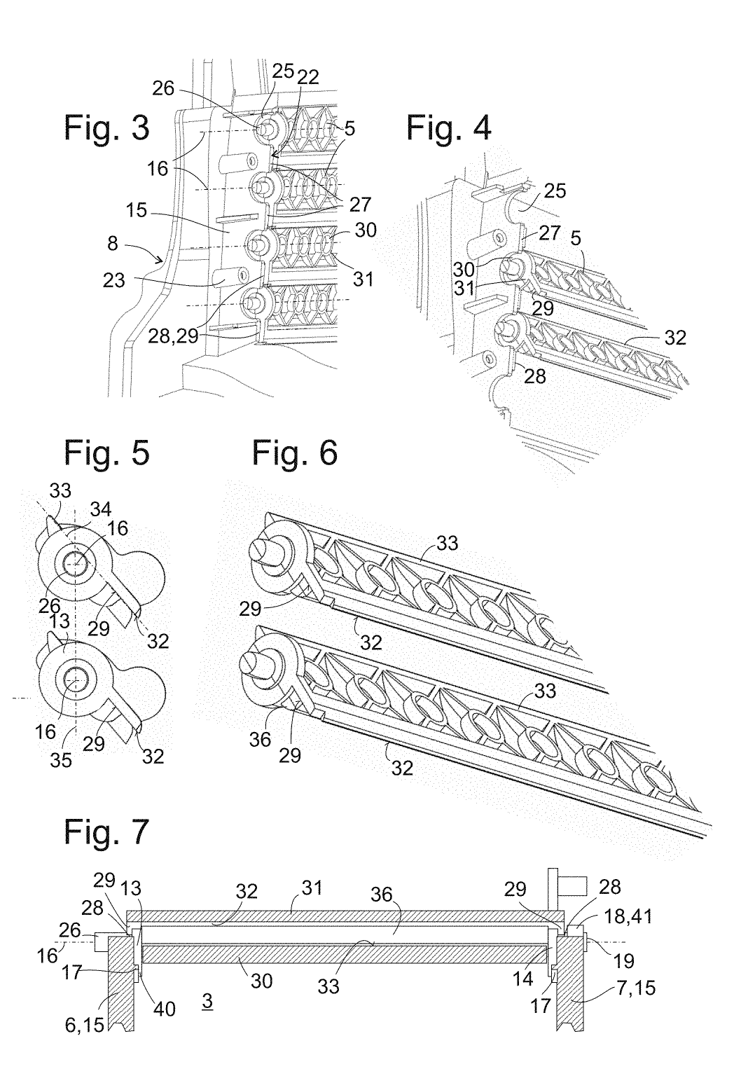

FIG. 3 shows a view of vertical strut 8 in which supporting rail 21 has been removed. This renders visible spacious recesses 25 in side wall 15 that are open towards the rear edge 22, and in which the axle journals 26 of vanes 5 engage. Respective sections 27 of rear edge 22 extend in the same plane between the recesses 25, which is parallel to the swivel axles 16 of the vanes 5 mounted on strut 8 but offset with respect to the plane 35 defined by swivel axles 16 into the interior of the vehicle. A part of each of these sections 27 forms a sealing surface 28, against which a sealing surface 29 of one of the vanes 5 lies flush.

The swivel axle 16 of a vane 5 may be considered to be the boundary between two blades 30, 31 of a vane, one of which 30 is advanced towards the radiator grille between the side walls 15 of the struts, while the other, 31, is retracted behind the rear edge 22 of the side walls 15 of the struts when vane 5 is swivelled out of the closed position shown in FIGS. 1-3. Each of the sealing surfaces 29 extend on the outer sides of these blades 31, which face away from the viewer in FIGS. 3 and 4, along the narrow sides thereof, and are therefore referred to in the following as the narrow side sealing surfaces 29.

A further sealing surface 32, referred to as the lengthwise sealing surface, extends along an edge of the outer side of blade 31 remote from the axle, over the entire length thereof from one narrow side sealing surface 29 to the other. This sealing surface 32 is more clearly visible in FIGS. 5 and 6 than in FIG. 4. As is shown particularly in FIG. 5, it extends in the same plane 34 as a lengthwise sealing surface 33 on the inner side of blade 30. In the closed position, planes 34 of vanes 5 are coincident and extend parallel to a plane 35 defined by the swivel axles 16, and the lengthwise sealing surfaces 32, 33 of adjacent vanes 5 touch each other.

There is no sealing surface 33 of a further vane 5 opposite the sealing surface 32 of the bottom vane 5, in the closed position this vane lies flush with a sealing surface of the lower horizontal strut 10. Similarly, sealing surface 31 of the topmost vane 5 is in contact with a sealing surface of the upper horizontal strut 9 in the closed position.

Narrow side sealing surfaces 29 may lie in the same plane 34 as the lengthwise sealing surfaces 32, 33, and in particular the narrow side sealing surfaces 29 may adjoin sealing surface 32 in flush manner. The common plane 34 serves as the logical boundary between two parts of the injection mould for the purposes of injection moulding the vanes 5.

FIG. 7 more clearly illustrates the location of sealing surfaces 28, 29, 32, 33 relative to each other in a cross-section that extends parallel to the swivel axles 16 of two vanes 5 and perpendicularly to the plane 35 defined by the swivel axles 16 and passes through blade 30 of one of the vanes and blade 31 of the other. FIG. 7 shows a partially open position between the closed position of FIG. 3 and the open position of FIG. 4, in which the lengthwise sealing surfaces 32, 33 of the two blades 30, 31 no longer touch each other in the section plane, but still face each other at a small distance, and the distance between the narrow side sealing surfaces 29 and the sealing surfaces 28 of struts 6, 7 is also still small. The sealing surfaces 29, 32 of blade 31, which lie flush against each other to form a continuous seal have been shifted out of the closed position, in which the narrow side sealing surfaces 29 lie flush with the sealing surfaces 28 of struts 6, 7; only a section 36 of the vane which is raised above the sealing surfaces 29, 32 and which is framed on the sides by sealing surfaces 29, 32 still engages between struts 6, 7. Blade 30 has been advanced out of the closed position, in which the lengthwise sealing surface 33 thereof is flush with sealing surfaces 28, into the opening 3 between struts 6, 7.

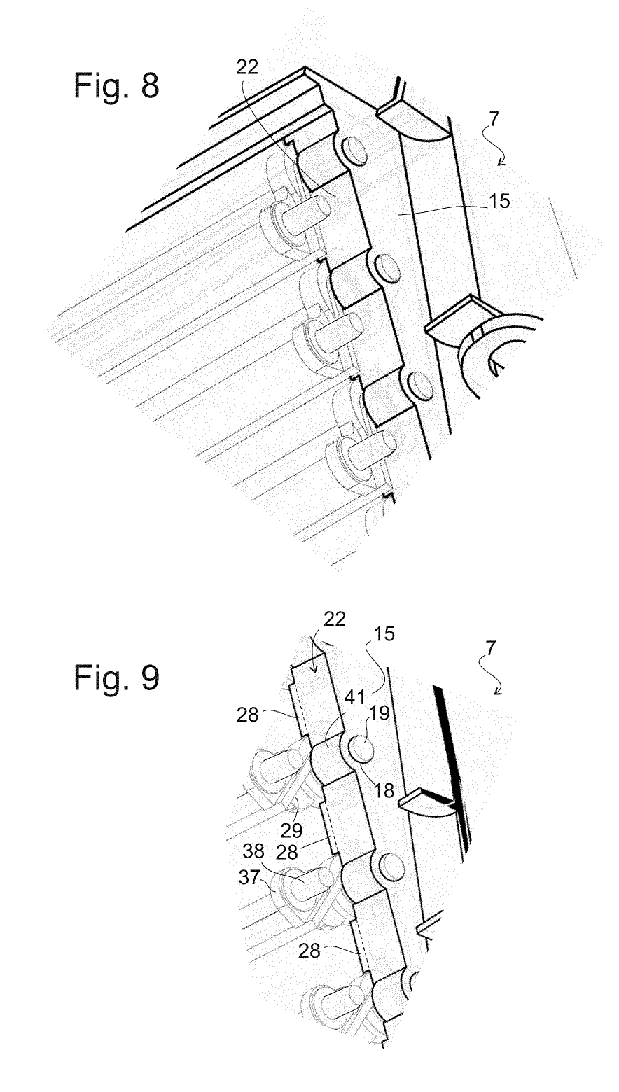

FIGS. 8 and 9 show a section of the middle vertical strut 7 and the ends of vanes 5 closest to the strut 7 in the closed and opened positions. In the open position of FIG. 9, sealing surfaces 28 on the rear edge 22 of side wall 15 of strut 7, which are covered in the closed position by the narrow side sealing surfaces 29 of vanes 5, are exposed. Arched pieces 41 which form a part of the bearing bushings 18 that support axle journal 19 protrude between two sealing surfaces 28. In strut 7, bearing bushings 18 are an integral component of side wall 15, with the result that when assembling air flap assembly 1 the vanes 5 need to be pushed into bearing bushings 18 in the axial direction. This is possible providing the supporting rail 21 has not yet been mounted on the opposite strut 6 or 8 and the axle journals 26 can be inserted loosely in recesses 25. To fit vanes 5 securely, in the next step the supporting rail 21 is placed over axle journals 26 from the side in the axial direction and screwed tight.

A lever arm 37 protrudes from the inner side of each vane 5 farthest from opening 3 and supports a journal 38 which is parallel to axle journal 19. Journals 38 engage in known manner in bearings of a common guide (not shown in the figure) so that each may be coupled to the others for swivelling.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment as contemplated herein. It should be understood that various changes may be made in the function and arrangement of elements described in an exemplary embodiment without departing from the scope of the invention as set forth in the appended claims.

1-15. (canceled)

16. An air flap assembly comprising:
a frame having two struts and an opening; and
a first vane supported on the two struts of the frame extending transversely to an axle pivotable between an open position and a closed position in the opening in the frame, wherein the axle divides the first vane into first and second blades, which are elongated in the direction of the axle and the length of the first blade is greater than the distance between the two struts and has at least one narrow side sealing surface, which in the closed position is located opposite a sealing surface of one of the struts forming a seal.

17. The air flap assembly according to claim 16, wherein the sealing surfaces have a surface aligned transversely to the axle.

18. The air flap assembly according to claim 16, further comprising a second vane extending transversely to a second axle pivotable between the open position and the closed position in the opening in the frame, wherein the second blade has a lengthwise sealing surface located opposite a lengthwise sealing surface of the first blade of the first vane forming a seal in the closed position.

19. The air flap assembly according to claim 18, wherein the narrow side sealing surface and the lengthwise sealing surface of the first blade lie in a common plane.

20. The air flap assembly according to claim 19, wherein the first blade and the axle lie on different sides of the common plane.

21. The air flap assembly according to claim 18, wherein the second blade of the first vane has a lengthwise sealing surface, and the lengthwise sealing surfaces of both blades lie in the common plane but on opposite sides of the vane.

22. The air flap assembly according to claim 16, wherein the first vane comprises a journal protruding axially beyond the second blade and engaging in a bearing bushing of the strut.

23. The air flap assembly according to claim 22, wherein the strut comprises a recess with an inner side concentric with the axle between the bearing bushing and the opening, and the first vane includes an outer surface extending in the circumferential direction having a radius larger than a radius of the journal and axially overlapping the inner side.

24. The air flap assembly according to claim 22, wherein the bearing bushing and the sealing surface are molded integrally on a first end of the strut.

25. The air flap assembly according to claim 24, wherein the bearing bushing comprises an arched piece protruding over the sealing surface of the first strut.

26. The air flap assembly according to claim 22, wherein a second strut is assembled from at least two components, of which a first component forms a sealing surface of the second strut and a second component forms at least a part of a bearing bushing.

27. The air flap assembly according to claim 26, wherein the second component forms at least a part of bearing bushings for multiple vanes.

28. The air flap assembly according to claim 16, wherein the two struts extending transversely to the axle are connected by two struts extending in the direction of the axle.

29. The air flap assembly according to claim 28, wherein the two struts extending transversely to the axle and the struts extending in the direction of the axle comprise a single part.

30. The air flap assembly according to claim 28, wherein each of the struts extending transversely to the axle comprises a sealing surface cooperating with a lengthwise sealing surface on one of the vanes.
